(19) United States
(12) Patent Application Publication
(10) Pub. No.: US 2009/0131298 A1
(43) Pub. Date: May 21, 2009

(54) Method for Producing Granulated Ammonium Nitriles

(76) Inventors: Georg Borchers, Bad Nauheim (DE); Andreas Schottstedt, Hofheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/555,290

(22) PCT Filed: Apr. 27, 2004
(86) PCT No.: PCT/EP04/04426

§ 371 Date: May 14, 2008

(30) Foreign Application Priority Data
May 2, 2003 (DE) 103 20 796.1

(51) Int. Cl. C11D 7/32; C11D 3/395

(52) U.S. Cl. 510/504; 510/513; 252/186.1

(57) ABSTRACT

A method for producing granulated ammonium nitriles is claimed which consists in granulating and simultaneously drying an ammonium nitrile together with a binder and optionally a further additive in a pneumatically generated fluidized bed.

The invention relates to a method for producing bleach activator granules comprising one or more ammonium nitrites, wherein the ammonium nitrile is granulated and simultaneously dried together with a binder and optionally further additives in the presence of water in a pneumatically generated fluidized bed. The fluidized bed granules are distinguished by very uniform morphology, high abrasion resistance, good storage stability, and by high active ingredient contents.

Bleach activators are important constituents in compact detergents, stain-removal salts and machine dishwashing detergents. Conventional bleach activators allow a bleaching result comparable with a boil wash at 40° C. to 60° C. by reacting with hydrogen peroxide donors (in most cases perborates, percarbonates, persilicates and perphosphates) to release an organic peroxycarboxylic acid.

The bleaching result which can be achieved is determined by the type and reactivity of the peroxycarboxylic acid formed, the structure of the bond to be perhydrolyzed, and the solubility in water of the bleach activator. Many substances are known according to the prior art as bleach activators. These are usually reactive organic compounds with an O-acyl or N-acyl group which can even react in the washing powder mixture, favored by the residual moisture present, with the bleach, such as, for example, sodium perborate if the two components are present in unprotected form.

Representative examples of bleach activators are N,N,N′,N′-tetraacetyl-ethylenediamine (TAED), nonanoylcaprolactam phenylsulfonate ester (APES), glucose pentaacetate (GPA), xylose tetraacetate (TAX), acyloxybenzenesulfonates (e.g. nonanoyloxybenzenesulfonate (NOBS), sodium 4-benzoyloxybenzenesulfonate (SBOBS), sodium trimethyl-hexanoyloxybenzenesulfonate (STHOBS)), diacetyldioxohexahydrotriazine (DADHT), tetraacetylglucoluril (TAGU), tetraacetylcyanic acid (TACA), di-N-acetyldimethylglyoxine (ADMG) and 1-phenyl-3-acetylhydantoin (PAH) and nitrilotriacetate (NTA). These bleach activators have the greatest degree of action in the temperature range from 40° C. to 60° C.

Ammonium nitrites (“nitrile quats”) form a particular class of cationic bleach activators. Compounds of this type develop their effects at low temperatures in the range from 10° C. to 50° C.

The production of nitrile quats and their use as bleach activator in bleaches are described in EP-A-0 303 520, EP-A-0 464 880, EP-A-0 458 396, EP-A-0 897 974 and EP-A-0 790 244.

WO 98/23531, WO 00/58273 and WO 00/36061 describe that ammonium nitrites, in particular cyclic ammonium nitrites for incorporation into solid detergents and cleaners, are converted to a solid form by stirring a carrier material with the largest possible surface area, for example silica, into an aqueous ammonium nitrile solution, or spraying the aqueous solution onto the carrier or mixing and drying the resulting mixture under reduced pressure at elevated temperatures. The granules and particles described in the specifications have water contents of up to 20% by weight, preferably less than 1% by weight. The high hygroscopicity and consequently the storage stability of these products, in particular of the linear ammonium nitriles, is unsatisfactory as the atmospheric moisture fluctuates, as is the partial decomposition of the hydrolysis-sensitive ammonium nitriles during the thermal drying process.

EP 1 122 300 describes bleaches which comprise, as bleach activator, an ammonium nitrile, optionally in a mixture with further bleach activators, for example alkanoyloxybenzenesulfonic acid or tetraacetylethylenediamine, and an inorganic peroxide and an alkali metal carbonate. The specification does not teach how the hydrolysis sensitivity of the ammonium nitrites can be minimized.

All of the methods described hitherto for formulating ammonium nitrites do not meet the requirements placed on compositions with a good bleaching effect over a broad temperature range, and a high storage stability of solid particles with high active ingredient contents to a satisfactory degree.

It was therefore the object to formulate nitrile quats, optionally with further bleach activators and additives, such that they are storage-stable and can be incorporated without problems into detergent and cleaner formulations.

The invention provides a method for producing granulated ammonium nitriles, wherein an ammonium nitrile is granulated and simultaneously dried together with a binder, and optionally a further additive in the presence of water in a pneumatically generated fluidized bed.

According to the invention, it is possible to granulate ammonium nitrites of the formula 1

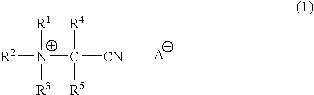

in which R¹, R², R³ are identical or different, and are linear or branched C₁-C₂₄-alkyl groups, C₂-C₂₄-alkenyl groups or are C₁-C₄-alkoxy-C₁-C₄-alkyl groups, substituted or unsubstituted benzyl, or in which R¹ and R² together with the nitrogen atom to which they are bonded form a ring having 4 to 6 carbon atoms which may be substituted by C₁-C₅-alkyl, C₁-C₅-alkoxy, C₁-C₅-alkanoyl, phenyl, amino, ammonium, cyano, cyanamino, chloro or bromide and, in addition to the nitrogen atom, can, instead of carbon atoms, comprise one or two oxygen or nitrogen atoms, a group N—R⁶ or a group R³—N—R⁶, in which R⁶ is hydrogen, C₁-C₅-alkyl, C₂-C₅-alkenyl, C₂-C₅-alkynyl, phenyl, C₇-C₈-arylalkyl, C₅-C₇-cycloalkyl, C₁-C₆-alkanoyl, cyanomethyl or cyano, R⁴ and R⁵ are hydrogen, C₁-C₄-alkyl, C₁-C₄-alkenyl, C₁-C₄-alkoxy-C₁-C₄-alkyl, phenyl or C₁-C₃-alkylphenyl, preferably hydrogen, methyl or phenyl, where in particular R⁴ is hydrogen if R⁵ is not hydrogen, and A is an anion, for example chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphosphonate, methanedisulfonate, methylsulfonate, ethanesulfonate or is an anion of the formulae R⁷SO₃^{θ}, R⁷SO₄^{θ} or R⁷COO^{θ}, in which R⁷ is C₁-C₂₀-alkyl, preferably C₁₀-C₁₈-alkyl, and additionally also C₁-C₁₈-alkylphenyl. Particular preference is given to cumenesulfonate and C₁₂/₁₈-alcohol sulfate as anion.

Preference is given to ammonium nitriles of the formula 2

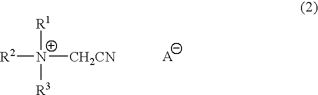

where R¹, R² and R³ are a linear or branched, saturated or unsaturated alkyl group having 1 to 24 carbon atoms, an alkenyl group having 2 to 24 carbon atoms or substituted or unsubstituted benzyl, A is any charge-balancing ion, for example chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphosphonate, methanedisulfonate, methylsulfonate, ethanesulfonate or is an anion of the formulae R⁷SO₃^{θ}, R⁷SO₄^{θ} or R⁷COO^{θ}, where R⁷ has the meanings given above. Particular preference is given to cumenesulfonate and C₁₂/₁₈-alcohol sulfate as anion.

Particular preference is given to compounds according to formula 2 in which R¹, R² and R³ are in each case a methyl group. The charge-balancing anion can be arbitrary, preferably chloride or methosulfate or a mixture of different anions, for example chloride or methosulfate and cumenesulfonate and/or lauryl sulfate and/or fatty acid alkyl carboxylates.

In a preferred embodiment, the ammonium nitriles are mixed together with further (second) bleach activators. These further bleach activators are solid and naturally have a different structure to the ammonium nitriles. Of suitability here are N,N,N′,N′-tetraacetylethylenediamine (TAED), nonanoylcaprolactam phenylsulfonate ester (APES), glucose pentaacetate (GPA), xylose tetraacetate (TAX), acyloxybenzenesulfonates (e.g. nonanoyloxybenzenesulfonate (NOBS), sodium 4-benzoyloxybenzene-sulfonate (S BOBS), sodium trimethylhexanoyloxybenzenesulfonate (STHOBS)), diacetyldioxohexahydrotriazine (DADHT), tetraacetylglucoluril (TAGU), tetraacetylcyanic acid (TACA), di-N-acetyldimethylglyoxine (ADMG), 1-phenyl-3-acetylhydantoin (PAH), nitrilotriacetate (NTA). A preferred co-bleach activator is TAED.

The total amount of all bleach activators, i.e. in the mixture of ammonium nitrile and further bleach activators based on the finished, dry, uncoated granules, is generally 25 to 70% by weight, preferably 30 to 60% by weight, in particular 45 to 55% by weight. The weight fraction of ammonium nitrile on its own, based on the finished, dry, uncoated granules, is generally 1 to 50% by weight, preferably 10 to 40% by weight, particularly preferably 15 to 35% by weight.

Suitable binders are cellulose and starch and ethers or esters thereof, for example carboxymethylcellulose (CMC), methylcellulose (MC) or hydroxyethylcellulose (HEC) and the corresponding starch derivatives, but also film-forming polymers, for example polyacrylic acids or salts thereof. Suitable binders for the purposes of this invention are, in particular, also pulverulent anionic components, in particular alkanesulfonates, alkylarylsulfonates, arylsulfonates, in particular cumene-xylene-toluenesulfonate, alkyl ether sulfates, alkyl sulfates, α-olefinsulfonates and soaps.

The amount of binders, based on the finished granules, can be 1 to 45% by weight, preferably 5 to 30% by weight.

In a preferred embodiment, the granules according to the invention additionally comprise further additives, preferably acidic additives which lower the hygroscopicity and hydrolysis sensitivity of the ammonium nitrile. Suitable acidic additives are sulfuric acid, sodium hydrogensulfate, phosphoric acid, sodium hydrogenphosphate, phosphonic acids and salts thereof, carboxylic acids or salts thereof, such as citric acid, in anhydrous or hydrated form, glycolic acid, succinic acid, succinic anhydride, glutaric acid, glutaric anhydride, adipic acid, adipic anhydride, maleic acid, maleic anhydride or lactic acid, but also acidic polymers. Particularly suitable acidic additives are polyacrylic acid, polymaleic acid or copolymers of acrylic acid and of maleic acid (Sokalan® grades).

The amount of acidic additive is such that the fraction of the acidic additive in the finished granules is approximately 0 to 30% by weight, preferably 1 to 20% by weight, in particular 10 to 18% by weight.

The method according to the invention can in principle be carried out by metering all of the components separately or together in solid form into the fluidized-bed apparatus and adding water for the granulation. Another option consists in introducing all of the components separately or together in the form of aqueous solutions or suspensions into the fluidized-bed apparatus. In practice, different variants of these methods are preferred, as described below. Since the ammonium nitrites are hygroscopic and are therefore difficult to isolate in solid form, it is advisable to use these ammonium nitrites in the granulation method according to the invention in the form of an aqueous solution, as is produced during the synthesis of these ammonium compounds. Additional further bleach activators, which are not ammonium nitriles, and binders and optionally acidic additives can then be metered in either in solid form, dissolved in the aqueous solution of the ammonium nitrites or as a separate aqueous solution.

In a preferred embodiment, an aqueous spray slurry comprising ammonium nitrile, a further bleach activator, binders and acidic additive, produced at room temperature, in a stirred container with stirring using a (mobile) Ultra-Turrax, optionally heated to a temperature of from 25° C. to 85° C., is pumped by means of a suitable pump (e.g. peristaltic pump) to the nozzle and sprayed into the fluidized bed from below.

For example, in this way it is possible to granulate a spray slurry which comprises in each case 25 to 30% by weight, preferably 27.8% by weight, of ammonium nitrile, Na cumenesulfonate and TAED, and 15 to 20% by weight, preferably 16.7% by weight, of Sokalan CP45, calculated as active ingredient fraction of the particular components in the final granules. This process variant, i.e. the introduction of all of the components in the form of an aqueous spray slurry, can be carried out either in round or in rectangular fluidized-bed apparatuses.

According to another preferred embodiment, only some of the second sheet metal catalyst is metered into the spray slurry comprising ammonium nitrile, binder and acidic additive, as described above, while the remainder of this second catalyst is added separately in solid form. The dust fractions on the finished granules, as are produced during the method according to the invention, can also be returned as solid to the fluidized bed. This returning of the dust fractions is in principle possible in all variants of the method according to the invention.

Such an additional solids feed, for example of dust-like fine fractions of the finished granules or of pulverulent formulation components, for example TAED, may also be advantageous in order to increase the germ concentration in the fluidized bed. The addition takes place either prior to atomization of the ammonium nitrile solution or preferably at the same time as this. The solid can also be added together with the solution of the ammonium nitrile, the mixing of these liquid constituents preferably taking place either prior to atomization or directly in the nozzle. Preferably, the metered addition of ground germ material, preferably with a particle size <1250 μm, takes place.

The finished granules are advantageously discharged from the fluidized bed via a size classification of the granules. This classification can take place via a central tube with a countercurrent stream of air (sifter air), which is regulated so that only particles above a certain particle size are discharged from the fluidized bed and smaller particles are retained in the fluidized bed. The particles discharged from the gas stream above the fluidized bed are separated off (e.g. filter or cyclone), optionally fine dust entrained by the gas can be separated off in a downstream separator, e.g. wet washer. The removed dust is returned to the fluidized bed in the region of the spray nozzle, where renewed wetting takes place.

Granules preferred according to the invention have a d50 value between 0.4 and 2.5 mm. In a particularly preferred embodiment, the particle fraction which is greater than 1.4 mm is returned. This coarse fraction can either be added to the fluidized bed following grinding as a solid component, or it is dissolved again and sprayed into the fluidized bed.

In a preferred embodiment, the air streaming in from below is composed of the heated and unheated sifter air and the heated bottom air. The bottom air temperature here is preferably between 85 and 95° C., preferably between 90 and 93° C. The fluidized air cools as a result of heat losses and as a result of the heat of evaporation of the constituents of the solvent. Consequently, the temperature of the bed mass which is established in the fluidized bed is 50 to 70° C., preferably 60 to 63° C. The air exit temperature is preferably between 55° C. and 65° C.

During the fluidized-bed granulation, the water content of the products can be adjusted within wide limits. In the method according to the invention, drying takes place at the same time as granulation in the fluidized bed.

In a preferred embodiment of the invention, the drying leads to the water content of the granules being <2% by weight and the bleach activator content being >50% by weight, based on uncoated cogranules.

Preferably used round fluidized-bed apparatuses have base plates measuring at least 0.4 m. In particular, preference is given to fluidized-bed apparatuses which have a base plate with a diameter between 0.4 m and 3 m, for example 1.2 m or 2.5 m. In a further preferred embodiment, the fluidized-bed apparatuses can be rectangular in shape. Base plates which may be used are a perforated base plate or a Conidur plate, a wire mesh or a combination base of a perforated plate with a grid.

The granules obtained according to the invention are directly suitable for use in detergents and cleaners. In a particularly preferred use form, however, they can be provided with a coating shell by methods known per se. For this, the granules are coated in an additional step with a film-forming substance, as a result of which the product properties can be influenced considerably. Suitable coating compositions are all film-forming substances, such as waxes, silicones, fatty acids, fatty alcohols, soaps, anionic surfactants, nonionic surfactants, cationic surfactants, anionic and cationic polymers, polyethylene glycols and polyalkylene glycols.

Of suitability are C₈-C₃₁-fatty acids (e.g. lauric acid, myristic acid, stearic acid), dicarboxylic acids, for example glutaric acid, adipic acid or anhydrides thereof; phosphonic acids, optionally phosphonic acids in a mixture with other customary coating compositions, in particular fatty acids, for example stearic acid, C₈-C₃₁-fatty alcohols; polyalkylene glycols (e.g. polyethylene glycols with a molar mass of from 1000 to 50 000 g/mol); nonionics (e.g. C₈-C₃₁-fatty alcohol polyalkoxylates having 1 to 100 mol of EO); anionics (e.g. alkanesulfonates, alkylbenzenesulfonates, α-olefin-sulfonates, alkyl sulfates, alkyl ether sulfates with C₈-C₃₁-hydrocarbon radicals); polymers (e.g. polyvinyl alcohols); waxes (e.g. montan waxes, paraffin waxes, ester waxes, polyolefin waxes); silicones.

The coating substance which softens or melts in the range from 30 to 100° C., moreover, can comprise further substances which do not soften or melt within this temperature range, in dissolved or suspended form, e.g.: polymers (e.g. homo-, co- or graft copolymers of unsaturated carboxylic acids and/or sulfonic acids, and alkali metal salts thereof, cellulose ether, starch, starch ether, polyvinylpyrrolidone); organic substances (e.g. mono- or polybasic carboxylic acids, hydroxycarboxylic acids or ether carboxylic acids with 3 to 8 carbon atoms, and salts thereof; dyes; inorganic substances (e.g. silicates, carbonates, bicarbonates, sulfates, phosphates, phosphonates).

Depending on the desired properties of the coated activator granules, the content of coating substance can be 1 to 30% by weight, preferably 5 to 15% by weight, based on coated activator granules.

To apply the coating substances, use may be made of mixers (mechanically induced fluidized bed) and fluidized-bed apparatuses (pneumatically induced fluidized bed). Possible mixers are, for example, plowshare mixers (continuous and batchwise), annular layer mixers and also Schugi mixers. When using a mixer, the heat treatment can take place in a granule prewarmer and/or in the mixer directly and/or in a fluidized bed downstream from the mixer. To cool the coated granules, granule coolers or fluidized-bed coolers can be used. In the case of fluidized-bed apparatuses, the heat treatment takes place via the heating gas used for the fluidizing. The granules coated by the fluidized-bed method can be cooled similarly to the mixer method via a granule cooler or a fluidized-bed cooler. Both in the case of the mixer method and also in the case of the fluidized-bed method, the coating substance can be sprayed on via a single-material or a dual-material nozzle device.

The heat treatment consists in a heat treatment at a temperature of from 30 to 100° C., but the same as or below the melting or softening temperature of the particular coating substance. Preference is given to working at a temperature which is just below the melting or softening temperature.

The precise temperature during the heat treatment or the temperature difference from the melting point of the coating substance is dependent on the coating amount, the heat-treatment time and the properties desired for the coated bleach activator granules and has to be determined for the particular system in preliminary experiments.

Examples thereof and a coating method are described in EP-A-0 835 926. By using these coating materials, the storage stability and hygroscopicity, and also the compatibility with other detergent constituents, in particular strongly alkaline components, can be further improved, and the reaction kinetics can be influenced in a targeted manner in order, in this way, to suppress interactions between the bleach activator and the enzyme system at the start of the washing process.

Moreover, the granules according to the invention can also comprise further suitable additives, such as anionic and nonionic surfactants, which contribute to a more rapid dissolution of the granules according to the invention, and bleach stabilizers, such as, for example, phosphonates and polyphosphonates be applied to granule core according to the invention.

Preferred anionic surfactants are alkali metal salts, ammonium salts, amine salts and salts of amino alcohols of the following compounds: alkyl ether sulfates, alkylamide sulfates and ether sulfates, alkylaryl polyether sulfates, monoglyceride sulfates, alkylamide sulfonates, alkyl sulfosuccinates, alkyl ether sulfosuccinates, alkylamide sulfosuccinates, alkyl sulfoacetates, alkylpolyglycerol carboxylates, alkyl phosphates, alkyl ether phosphates, alkyl sarcosinates, alkyl polypeptidates, alkylamidopolypeptidates, alkyl isethionates, alkyl taurates, alkyl polyglycol ether carboxylic acids or fatty acids, such as oleic acid, ricinoleic acid, palmitic acid, stearic acid, copra oil acid salt or hydrogenated copra oil acid salts. The alkyl radical of all of these compounds normally comprises 8-32, preferably 8-22, carbon atoms. Preferred nonionic surfactants are polyethoxylated, polypropoxylated or polyglycerylated ethers of fatty alcohols, polyethoxylated, polypropoxylated and polyglycerylated fatty acid esters, polyethyloxylated esters of fatty acids and of sorbitol, polyethoxylated or polyglycerylated fatty amides. Likewise suitable additives are complexing agents and transition metal complexes, e.g. iron-, cobalt- or manganese-containing metal complexes as described in EP-A-0 458 397 and EP-A-0 458 398.

Further possible additives are substances which react in the wash liquor with the peroxycarboxylic acid released from the activator to form reactive intermediates, such as dioxiranes or oxaziridines and, in so doing, can increase the reactivity. Corresponding compounds are ketones and sulfonimines corresponding to U.S. Pat. No. 3,822,114 and EP-A-0 446 982.

The amount of additive depends in particular on its nature. For example, acidifying additives and organic activators for increasing the performance of the peracid are added in amounts of from 0 to 20% by weight, in particular in amounts of from 1 to 10% by weight, based on the total weight, whereas metal complexes are added in concentrations in the ppm range.

The granules produced according to the invention are distinguished by very good storage stability in pulverulent detergent, cleaner and disinfectant formulations. They are ideal for use in standard detergents, stain-removal salts, machine dishwashing detergents, pulverulent all-purpose cleaners and denture cleaners.

In these formulations, the granules according to the invention are used in combination with a source of hydrogen peroxide. Examples thereof are perborate monohydrate, perborate tetrahydrate, percarbonates, alkali metal persulfates, persilicates and percitrates, where sodium is the preferred alkali metal, and hydrogen peroxide adducts onto urea or amine oxides. Additionally or alternatively, peroxycarboxylic acids, for example dodecanediperacid or phthalimidopercarboxylic acids, which may be optionally substituted on the aromatic, may be present. The addition of small amounts of known bleach stabilizers, such as, for example, of phosphonates, borates, or metaborates and metasilicates, and magnesium salts, such as magnesium sulfate, may be advantageous.

In addition, the formulation corresponding to the prior art can have further detergent ingredients, such as surfactants of nonionic, anionic, cationic or amphoteric nature, organic and inorganic builders and cobuilders, enzymes, bleach activators, bleach catalysts, salts, optical brighteners, graying inhibitors, foam inhibitors, sequestrants, and fragrances and dyes.

Preferred nonionic surfactants are fatty alcohol oxethylates with about 1 to about 25 mol of ethylene oxide. The alkyl chain of the aliphatic alcohols can be linear or branched, primary or secondary, and generally comprises from 8 to 22 carbon atoms. Particular preference is given to the condensation products of alcohols which comprise an alkyl chain of from 10 to 20 carbon atoms with 2 to 18 mol of ethylene oxide per mole of alcohol. The alkyl chain can be saturated or unsaturated. The alcohol ethoxylates can likewise have a narrow homolog distribution of the ethylene oxide (narrow range ethoxylates) or a broad homolog distribution of the ethylene oxide (broad range ethoxylates). Examples of commercially available nonionic surfactants of this type are Tergitol™ 15-S-9 (condensation product of a C11-C15 linear secondary alcohol with 9 mol of ethylene oxide) Tegitol™ 24-L-NMW (condensation product of a C₁₂-C₁₄-linear primary alcohol with 6 mol of ethylene oxide having a narrow molecular weight distribution). This product class likewise includes the Genapol™ grades from Clariant GmbH.

Moreover, other known types of nonionic surfactants are also suitable, such as polyethylene, polypropylene, polybutylene and polypentylene oxide adducts of fatty alcohols with 8-22 carbon atoms and alkylphenols having 6 to 12 carbon atoms in the alkyl chain, addition products of ethylene oxide with a hydrophobic base formed from the condensation of propylene oxide with propylene glycol or addition products of ethylene oxide with a reaction product of propylene oxide and ethylenediamine.

Furthermore, semipolar nonionic surfactants, for example amine oxides, can be used.

Suitable amine oxides are particularly C₁₀-C₁₈-alkyldimethylamine oxides and C₈-C₁₂-alkoxyethyldihydroxyethylamine oxides.

Suitable anionic surfactants are primarily straight-chain and branched alkyl sulfates, -sulfonates, carboxylates, phosphates, alkyl ester sulfonates, arylalkylsulfonates, alkyl ether sulfates and mixtures of said compounds. The text below will describe some of the suitable types of anionic surfactants in more detail.

### Alkyl Ester Sulfonates

Alkyl ester sulfonates represent linear esters of C₃-C₂₀-carboxylic acids (i.e. fatty acids) which are sulfonated by SO₃, as described in “The Journal of the American Oil Chemists Society”, 52 (1975), pp. 323-329. Suitable starting materials are natural fatty derivatives such as, for example, tallow or palm oil fatty acid.

### Alkyl Sulfates

Alkyl sulfates are water-soluble salts or acids of the formula ROSO₃M, in which R is preferably a C₁₀-C₂₄-hydrocarbon radical, preferably an alkyl or hydroxyalkyl radical having 10 to 20 carbon atoms, particularly preferably a C₁₂-C₁₈-alkyl or hydroxyalkyl radical. M is hydrogen or a cation, e.g. an alkali metal cation (e.g. sodium, potassium, lithium) or ammonium or substituted ammonium, e.g. a methyl-, dimethyl- and trimethylammonium cation or a quaternary ammonium cation, such as tetramethylammonium and dimethylpiperidinium cation and quaternary ammonium cations, derived from alkylamines such as ethylamine, diethylamine, triethylamine and mixtures thereof. Alkyl chains with C₁₂-C₁₆ are preferred here for low washing temperatures (e.g. below about 50° C.) and alkyl chains with C₁₆-C₁₈ are preferred for higher washing temperatures (e.g. above about 50° C.).

### Alkyl Ether Sulfates

The alkyl ether sulfates are water-soluble salts or acids of the formula RO(A)ₘSO₃M, in which R is an unsubstituted C₁₀-C₂₄-alkyl or hydroxyalkyl radical having 10 to 24 carbon atoms, preferably a C₁₂-C₂₀-alkyl or hydroxyalkyl radical, particularly preferably a C₁₂-C₁₈-alkyl or hydroxyalkyl radical. A is an ethoxy or propoxy unit, m is a number greater than 0, typically between about 0.5 and about 6, particularly preferably between about 0.5 and about 3 and M is a hydrogen atom or a cation, such as, for example, a metal cation (e.g. sodium, potassium, lithium, calcium, magnesium, etc.), ammonium or a substituted ammonium cation. Examples of substituted ammonium cations are methyl-, dimethyl-, trimethylammonium and quaternary ammonium cations, such as tetramethylammonium and dimethylpiperidinium cations, and those which are derived from alkylamines, such as ethylamine, diethylamine, triethylamine, mixtures thereof and the like. Examples which may be mentioned are C₁₂-C₁₈-alkyl polyethoxylate (1.0) sulfate, C₁₂-C₁₈-alkyl polyethoxylate (2.25) sulfate, C₁₂-C₁₈-alkyl polyethoxylate (3.0) sulfate, C₁₂-C₁₉-alkyl polyethoxylate (4.0) sulfate, where the cation is sodium or potassium.

Other anionic surfactants which are useful for use in detergents and cleaners are C₉-C₂₄-olefinsulfonates, sulfonated polycarboxylic acids prepared by sulfonation of the pyrolysis products of alkaline earth metal citrates, as described, for example, in the British patent GB 1,082,179, alkyl glycerol sulfates, fatty acyl glycerol sulfates, oleyl glycerol sulfates, alkylphenol ether sulfates, linear or branched alkylbenzenesulfonates, primary and secondary paraffinsulfonates, alkyl phosphates, alkyl ether phosphates, isethionates, such as acyl isethionates, N-acyltaurides, alkyl succinamates, sulfosuccinates, monoesters of the sulfosuccinates (particularly saturated and unsaturated C₁₂-C₁₈-monoesters) and diesters of the sulfosuccinates (particularly saturated and unsaturated C₁₂-C₁₈-diesters), acyl sarcosinates, sulfates of alkylpolysaccharides, such as sulfates of alkylpolyglycosides, branched primary alkyl sulfates and alkyl polyethoxycarboxylates, such as those of the formula RO(CH₂CH₂)ₖCH₂COO⁻M⁺, in which R is a C₈-C₂₂-alkyl, k is a number from 0 to 10 and M is a cation which forms a soluble salt; Resin acids or hydrogenated resin acids, such as rosin or hydrogenated rosin or tall oil resins and tall oil resin acids can likewise be used. Further examples are described in “Surface Active Agents and Detergents” (Vol. I and II, Schwartz, Perry and Berch). A large number of such surfactants are also claimed in the U.S. Pat. No. 3,929,678.

Examples of amphoteric surfactants which can be used in the formulations of the present invention are primarily those which are described as derivatives of aliphatic secondary and tertiary amines in which the aliphatic radical may be linear or branched and in which one of the aliphatic substituents contains between 8 and 18 carbon atoms and comprises an anionic, water-soluble group, such as, for example, carboxy, sulfonate, sulfate, phosphate or phosphonate.

Preferred amphoteric surfactants are monocarboxylates and dicarboxylates, such as cocoamphocarboxypropionate, cocoamidocarboxypropionic acid, cocoamophocarboxyglycinate (or also referred to as cocoamphodiacetate) and cocoamphoacetate.

Further preferred amphoteric surfactants are alkyldimethylbetaines, alkyl-amidobetaines and alkyldipolyethoxybetaines with an alkyl radical, which may be linear or branched, having 8 to 22 carbon atoms, preferably having 8 to 18 carbon atoms and particularly preferably having 12 to 18 carbon atoms. These compounds are marketed, for example, by Clariant GmbH under the trade name Genagen® CAB and LAB.

Typical examples of cationic surfactants are quaternary ammonium compounds, ester quats, ether quats, hydroxyethyl quats, ethoxylated quats, in particular quaternized fatty acid alkanolamine ester salts and dialkylaminopropylamine ester salts.

Suitable organic and inorganic builder substances are neutral or, in particular, alkaline salts which are able to precipitate out or complex calcium ions. Suitable and particularly ecologically acceptable builder substances, such as finely crystalline, synthetic water-containing zeolites of the NaA type which have a calcium-binding capacity in the range from 100 to 200 mg of CaO/g are preferably used. Besides zeolite, preference is also given to using sheet silicates and amorphous silicates. Likewise suitable are alkali metal phosphates which can be in the form of their alkaline, neutral or acidic sodium or potassium salts. Examples thereof are trisodium phosphate, tetrasodium diphosphate, disodium dihydrogendiphosphate, pentasodium triphosphate, so-called sodium hexametaphosphate, oligomeric trisodium phosphate with degrees of oligomerization of from 5 to 1000, in particular 5 to 50, and mixtures of sodium and potassium salts. Organic builder substances which can be used are, for example, the carboxylic acids used preferably in the form of their sodium salts, such as citric acid, nitriloacetate (NTA), and ethylenediaminetetraacetic acid, provided such a use is not objectionable on ecological grounds, and phosphonic and polyphosphonic acids. Analogously to this it is also possible to use polymeric carboxylates and salts thereof. These include, for example, the salts of homopolymeric or copolymeric polyacrylates, polymethacrylates and, in particular, copolymers of acrylic acid with maleic acid, preferably those of 50% to 10% maleic acid, and polyaspartic acid and also polyvinylpyrrolidone and urethanes. The relative molecular mass of the homopolymers is generally between 1000 and 100 000, that of the copolymers is between 2000 and 200 000, preferably 50 000 to 120 000, based on the free acid, in particular water-soluble polyacrylates are suitable which are crosslinked, for example, with about 1% of a polyallyl ether of subrose and which have a relative molecular mass above one million. Examples thereof are the polymers obtainable under the name Carbopol 940 and 941.

Suitable enzymes are those from the class of proteases, lipases, amylases, pullinases, cutinases, and cellulases and mixtures thereof. Proteases which are available are BLAP®, Opticlean®, Maxacal®, Maxapem®, Esperase®, Savinase®, Purafect®, OxP and/or Duraxym®, amylases which are available are Termamyl®, Amylase-LT®, Maxamyl®, Duramyl® and/or Pruafect® OxAm, and lipases which are available are Lipolase®, Lipomax®, Lumafast® and/or Lipozym®.

The enzymes can be adsorbed to carrier substances and/or embedded in coating substances.

In addition to the bleach activator granules produced according to the invention or, the detergent formulations can also comprise the sulfonimines known from EP 446 982 and EP 453 003 and/or bleach-boosting transition metal salts or transition metal complexes as so-called bleach catalysts.

Salts and extenders used are, for example, sodium sulfate, sodium carbonate or sodium silicate (waterglass).

Further constituents of the detergent formulation may be optical brighteners, for example derivatives of diaminostilbenedisulfonic acid or alkali metal salts thereof, and foam inhibitors, such as fatty acid alkyl ester alkoxylates, organopolysiloxanes and mixtures thereof with microfine, optionally silanized silica, and paraffins, waxes, microcrystalline waxes and mixtures thereof with silanized silica. Mixtures of different foam inhibitors can also be used advantageously, e.g. those from silicone oil, paraffin oil or waxes. Preferably, foam inhibitors are bound to a granular carrier substance which is soluble or dispersible in water. In order to bind traces of heavy metals, the salts of polyphosphonic acids, such as 1-hydroxyethane-1,1-diphosphonic acid (HEDP), ethylenediaminetetramethylenephosphonic acid (EDTMP) and diethylenetriaminepentamethylenephosphonic acid (DTPMP), can be added. Typical individual examples of further additives are sodium borate, cellulose and starch, and ethers and esters thereof, sucrose, polydextrose and polymeric additives.

The examples below are intended to illustrate the invention in more detail without limiting it thereto.

Granulation of trimethylacetonitrile methosulfate/TAED cogranules in the fluidized-bed process

### EXAMPLE 1

### Laboratory Granulation

### 1) Preparation of a Spray Slurry:

In the first step, 486.1 g of a 40% strength aqueous Na cumenesulfonate solution were mixed with 259.3 g of a 45% strength aqueous Sokalan C45 solution at room temperature. Then, in steps, 422.7 g of a 55.6% strength aqueous ammonium nitrile solution were added, the active content of the solution being about 46%. In order, during the addition of the ammonium nitrile solution, to avoid partial, temporary precipitations of a mixed salt of ammonium nitrile and Na cumenesulfonate, the mixing solution was intensively homogenized during the addition using an Ultra-Turrax. In the last step, 194.4 g of TAED powder (without precomminution) were added and the suspension was likewise treated for about 5 min with the Ultra-Turrax in order to comminute the TAED crystals. Although the suspension prepared in this way had an increased viscosity and had to be stirred constantly to avoid sedimentations, the slurry was highly concentrated (solids content about 55%) and could be conveyed at room temperature (i.e. without complex heat-treatment) without problems using a peristaltic pump and be atomized via a dual-material nozzle.

### 2) Fluidized-Bed Granulation:

For laboratory experiments, a batchwise operating laboratory fluidized bed of type GPCG 1.1 from Glaft with an inflow diameter D=150 mm was used, the spray nozzle spraying into the fluidized bed from below.

In order to be able to operate the granulation process, a fluidized mass is required onto which the active ingredient solution can be sprayed. Specifically at the start of a process development there is generally no suitable fluidized mass available, meaning that it is usually necessary to start with a carrier material. However, this has the disadvantage that the process has to be operated over a very long period until the original starter material has been reliably replaced and only the actual target product is still present in the fluidized bed. In the case of the formulation investigated here, it was found that this could be spray-dried very readily in the fluidized-bed apparatus. It was thus possible to dispense with the use of a carrier substance and to generate a spray-dried powder with the desired target composition as fluidized bed. A laborious exchange process was thus no longer necessary. After the start-up and exchange phase described above had passed, a targeted granulation of the product could be carried out without problems. The gas volume stream for fluidizing the bed material was about 33 m³/h. The inlet air temperature was limited to about 95° C., which ensured a sufficient distance from softening and sintering effects of the product which started at about 110° C. Setting a spray output of about 12-19 g/min of solution (corresponding to about 8-10 g/min of solid) the temperature which was established in the fluidized bed was about 62-63° C., this temperature level being kept stable. With these operating conditions, an exit air temperature of about 56-57° C. was established. At the initially chosen spray gas pressure of p=0.8 bar, it was found that the granules had a rather uneven structure (no spherical shape, irregular surface). Better results and more uniform granules were achieved by increasing the spray gas pressure to p=1 bar.

Using these experimental settings, a granule yield of about 81% was achieved for the target particle range from 630-1250 μm. The bulk density of the granules was 510 g/l. The composition of the final granules was 26.3% by weight of ammonium nitrile, 26.3% by weight of TAED, 26.3% by weight of Na cumenesulfonate, 15.8% by weight of Sokalan CP 45 (ratio based on washing-active substance=1:1:1:0.6), and 5.3% by weight of secondary components.

### EXAMPLE 2

### Laboratory Granulation with TAED as Separate Solid Addition

### 1) Preparation of a Spray Slurry:

In the first step, 347.2 g of a 40% strength aqueous Na cumenesulfonate solution were mixed with 185.2 g of a 45% strength aqueous Sokalan C45 solution at room temperature. Then, in steps, 284.6 g of a 59% strength aqueous ammonium nitrile solution were added, the active content of the solution being about 49%. In order, during the addition of the ammonium nitrile solution, to avoid partial, temporary precipitations of a mixing salt of ammonium nitrile and Na cumenesulfonate, the mixing solution was intensively homogenized during the addition using an Ultra-Turrax.

### 2) Fluidized-Bed Granulation:

For laboratory experiments, a batchwise operating laboratory fluidized bed of the type GPCG 1.1 from Glatt with an inflow diameter of D=150 mm was used, the spray nozzle spraying onto the fluidized bed from above.

The TAED amount of 139 g required to complete the formulation was initially introduced into the laboratory fluidized bed together with 495.7 g of fluidized-bed material from preliminary experiments (granules and comminuted coarse material). The material was fluidized with a gas volume stream of about 22-31 m³/h, the gas inlet temperature being about 90-95° C. Over a period of 45 min, 810 g of the spray slurry were sprayed into the fluidized bed at a metering rate of 14-22 g/min. During this, a temperature in the fluidized bed of about 63-71° C. was established. With these experimental settings, a granule yield of about 49% was achieved for the target particle range from 630-1250 μm. The bulk density of the granules was 472 g/l. The composition of the final granules was 26.3% by weight of ammonium nitrile, 26.3% by weight of TAED, 26.3% by weight of Na cumenesulfonate, 15.8% by weight of Sokalan CP 45 (ratio based on washing-active substance=1:1:1:0.6), and 5.3% by weight of secondary components.

1. A method for producing granulated ammonium nitriles, wherein an ammonium nitrile is granulated and simultaneously dried together with a binder and an acidic additive in a pneumatically generated fluidized bed.

2. The method as claimed in claim 1, wherein the ammonium nitrile granulated is a compound of the formula 1 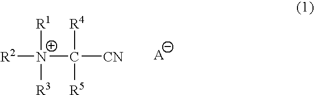
in which R¹, R², R³ are identical or different, and are linear or branched C₁-C₂₄-alkyl groups, C₂-C₂₄-alkenyl groups or are C₁-C₄-alkoxy-C₁-C₄-alkyl groups, substituted or unsubstituted benzyl, or in which R¹ and R² together with the nitrogen atom to which they are bonded form a ring having 4 to 6 carbon atoms which may be substituted by C₁-C₅-alkyl, C₁-C₅-alkoxy, C₁-C₅-alkanoyl, phenyl, amino, ammonium, cyano, cyanamino, chloro or bromide and, in addition to the nitrogen atom, can, instead of carbon atoms, comprise one or two oxygen or nitrogen atoms, a group N—R⁶ or a group R³—N—R⁶, in which R⁶ is hydrogen, C₁-C₅-alkyl, C₂-C₅-alkenyl, C₂-C₅-alkynyl, phenyl, C₇-C₈-arylalkyl, C₅-C₇-cycloalkyl, C₁-C₆-alkanoyl, cyanomethyl or cyano, R⁴ and R⁵ are hydrogen, C₁-C₄-alkyl, C₁-C₄-alkenyl, C₁-C₄-alkoxy-C₁-C₄-alkyl, phenyl or C₁-C₃-alkylphenyl, preferably hydrogen, methyl or phenyl, where in particular R⁴ is hydrogen if R⁵ is not hydrogen, and A is an anion.

3. The method as claimed in claim 1, wherein the ammonium nitrile granulated is a compound of the formula 2 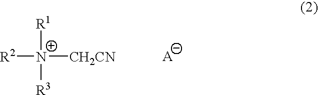
where R¹, R² and R³ are a linear or branched, saturated or unsaturated alkyl group having 1 to 24 carbon atoms, an alkenyl group having 2 to 24 carbon atoms or substituted or unsubstituted benzyl, and A is an anion.

4. The method as claimed in claim 1, wherein a compound of the formula 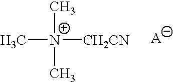
is granulated, where A is an anion.

5. The method as claimed in claim 1, wherein an ammonium nitrile is granulated together with a further bleach activator.

6. The method as claimed in claim 1, wherein an ammonium nitrile is granulated together with TAED.

7. The method as claimed in claim 1, wherein the binder is selected from the group consisting of alkanesulfonates, alkylarylsulfonates, arylsulfonates, in particular cumene-, xylene-, toluenesulfonate, alkyl ether sulfates, alkyl sulfates, α-olefinsulfonates, soaps, and mixtures thereof.

8. The method as claimed in claim 1, wherein the acidic additive is selected from the group consisting of polyacrylic acid, polymaleic acid, copolymers of acrylic acid and maleic acid, and mixtures thereof.

9. The method as claimed in claim 1, wherein a finished granule has 25 to 70% by weight of bleach activator including the ammonium nitrile, 1 to 45% by weight of binder and 1 to 30% by weight of the acidic additive, in each case based on the finished granule.

10. The method as claimed in claim 1, wherein an aqueous spray slurry comprising ammonium nitrile, binder, a further bleach activator and acidic additive is granulated.

11. The method as claimed in claim 1, wherein an aqueous spray slurry comprising ammonium nitrile, binder and acidic additive is granulated with the simultaneous separate metered addition of a further bleach activator in solid form.

12. The method as claimed in claim 1, wherein an aqueous spray slurry is granulated which comprises ammonium nitrile, binder, acidic additive and a partial amount of a further bleach activator with the simultaneous separate metered addition of the remaining partial amount of the further bleach activator in solid form.

13. A detergent, bleach or cleaner comprising a granulated ammonium nitrile produced as in claim 1.

14. A method for producing an ammonium nitrile granule, said method comprising introducing a stream comprising ammonium nitrile, a binder, and an acidic additive to a pneumatically generated fluidized bed dryer and therein simultaneously granulating and drying the stream to provide the ammonium nitrile granule.

15. The method of claim 14, wherein the stream is an aqueous spray slurry.

16. The method of claim 14, wherein the stream further comprises a further bleach activator in solid form.

17. The method of claim 14, further comprising simultaneously metering to said fluidized bed dryer a separate stream comprising a further bleach activator in solid form.
